(19) United States
(12) Patent Application Publication
(10) Pub. No.: US 2011/0208735 A1
(43) Pub. Date: Aug. 25, 2011

(54) Learning Term Weights from the Query Click Field for Web Search

(75) Inventors: Jianfeng Gao, Kirkland, WA (US); Krysta M. Svore, Seattle, WA (US)

(73) Assignee: Microsoft Corporation, Redmond, WA (US)

(21) Appl. No.: 12/710,360

(22) Filed: Feb. 23, 2010

(51) Int. Cl. G06F 15/18; G06F 17/30

(52) U.S. Cl. 707/730; 706/12; 707/E17.109

(57) ABSTRACT

Described is a technology by which a term frequency function for web click data is machine learned from raw click features extracted from a query log or the like and training data. Also described is using combining the term frequency function with other functions/click features to learn a relevance function for use in ranking document relevance to a query.

### BACKGROUND

A web document is associated with several distinct fields of information, including the title of the web page, the body text, the URL, the anchor text, and the query click field (the queries that lead to a click on the page). The title, body text and URL fields are usually referred to as the content fields, while the anchor text and the query click field are usually referred to as the popularity fields.

The click field comprises a set of queries that have clicks on a document, and thus forms a text description of the document from the users' perspectives. The use of click data for Web search ranking may significantly improve the accuracy of ranking models, and thus the query click field may be one of the most effective fields with respect to web searching.

In web search ranking, each query (or query term) in the click field needs to be assigned a weight, which represents the importance of the query (or query term) in describing the relevance of the document. In the content fields, term weights are usually derived from term frequency, such as via the well known TF-IDF (term frequency-inverse document frequency) weighting function.

However, in the click field, term frequency is not well-defined. For example, if the data shows that the same query resulted in the same document being clicked twice, the term frequency of the query cannot (at least not objectively) simply be defined as two (2) because users click a document for different reasons, and all clicks cannot be treated equally. For example, users may click to receive a document because the document is indeed relevant to the query, but may instead do so only because the document is ranked high, yet turns out to be irrelevant to that user (e.g., whereby a user soon leaves the page).

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which collected data (e.g., session data) is processed into query click field data, such as features (functions) and/or heuristic functions. From these features/functions, weight of terms for a term frequency function are learned by a machine learning algorithm that uses labeled training data.

In one aspect, the learned term frequency function may be combined with one or more other functions/features by a ranking function to produce a relevance function. The relevance function may be used to rank the relevance of documents to a query.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for learning and using term frequency based upon a click field.

FIG. 2 is a block diagram showing example components for combing term frequency functions into a combined term weighting function (a relevance function) for ranking.

FIG. 3 shows an illustrative example of a computing environment into which various aspects of the present invention may be incorporated.

### DETAILED DESCRIPTION

Various aspects of the technology described herein are generally directed towards automatically learning (via machine learning) a term frequency function/model for the click field from raw click features and a large training collection. Also described is using the model to learn a relevance function for ranking based on click field data and the learned term frequency function, as well as possibly other functions. Learning may include deriving term weights based upon the query click field for web search terms. Two example classes of methods are described herein for automatically learning the term weights from training data, namely learning term-frequency, and learning ranking scores for click-based ranking features.

It should be understood that any of the examples described herein are non-limiting examples. As one example, while web search is one application of where term frequency learning as described herein is used, any other application where term frequency is used, such as language models, may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and search technology in general.

By way of background, consider a document with only one field (e.g., an unstructured document) and assume that the document d belongs to a collection C. The document can be represented by a vector d=(d₁, . . . , d_{V}), where dⱼ denotes the term frequency of the j-th term in d and V is the total number of terms in the vocabulary.

In order to score the relevance of such a document against a query q, most ranking functions define a term weighting function wₜ(d, C), defined for term t where tεq, which exploits term frequency as well as other factors such as the document's length and collection statistics. For example, the well-known TF-IDF term weighting function can be defined as wₜ(d, C)=TFₜ×IDFₜ, where TFₜ is the term frequency function, whose value can be a raw term frequency (i.e., the number of occurrence of the term in the document) or a normalized term frequency. IDFₜ is the inverse document frequency function defined, for example, as

$${IDF}_{t} = log \frac{N}{{n}_{t}} ,$$

where N is the number of documents in the collection, and nₜ
is the number of documents in which term t occurs.

Then, the relevance score of d given q may be calculated by adding the term weights of terms matching the query q:

Score(d,q,C)=Σ_{tεq}wₜ(d,C)

The term weights generally depend upon how the term frequency is defined, which is heretofore not well-defined for the click field.

One current solution defines a heuristic term frequency function over raw click features. However, given even a relatively small number of raw click features (e.g., click counts, last click counts, the number of impressions, the dwell time, and so forth), the number of possible forms of heuristic functions is prohibitively large, and it is not realistically possible to evaluate all of them.

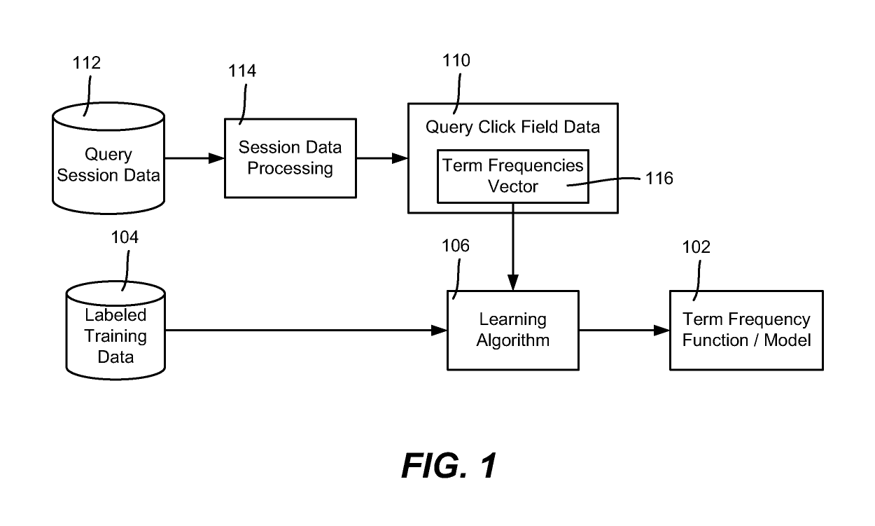

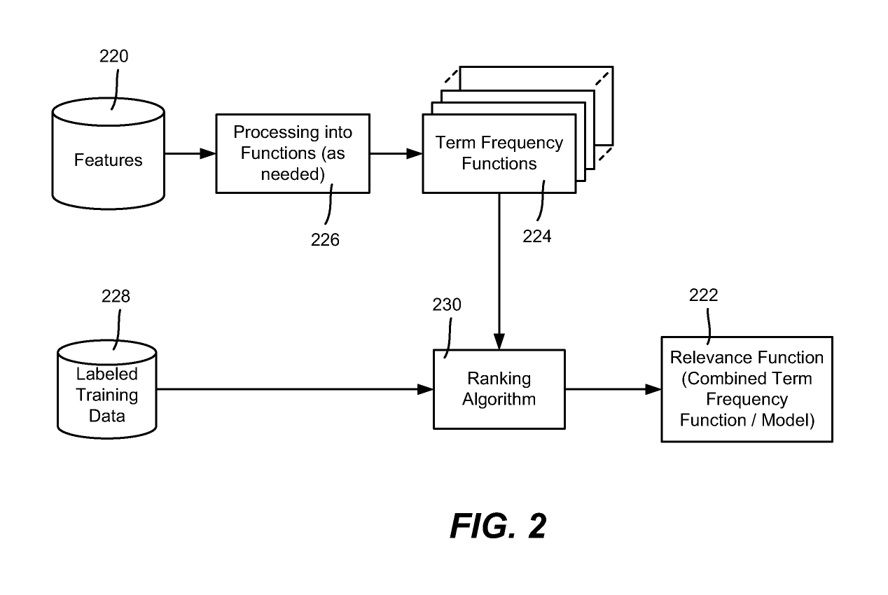

The technology described herein and represented in FIG. 1 automatically learns the term frequency function/model 102 for click data, e.g., over a relatively large data collection. Also described and represented in FIG. 2 is learning a relevance function for ranking term frequency functions/models, e.g., based on the learned term frequency function/model 102 and other raw click features. By using an appropriate proper objective function and training algorithm, the functions may be optimized for web search, for example.

To this end, FIG. 1 shows various aspects related to automatically learning the term weights of a term frequency function/model 102 from labeled training data 104. In one implementation, the term frequency function for the click field is learned using a boosted tree algorithm. Any appropriate learning algorithm 106 may be used, including RankNet, LambdaMART, RankSVM and so forth.

Query click field data 110 is built from the query session data 112, e.g. via session data processing 114 as described below. Note that a query session contains a user-issued query and a ranked list of a number of (e.g., ten) documents, each of which may or may not be clicked by the user. The click field for a document d contains the session queries qₛ that resulted in d being shown in the top ten results, for example. The click fields (data) 110 may be extracted from a large number (e.g., one year's worth) of a commercial search engine's query log files. Other sources include toolbar logs, browser logs, any user feedback log (e.g., social networking logs, microblog logs), and the like.

In one implementation, rather than determining the term frequency of each term in the click field, each query qₛ may be treated as a single unit, or multiword “term”. As used herein, “term” refers to a unique session query qₛ in the click field data 110.

To process the session data, the term frequency function for query qₛ in the click field TF(d, qₛ) may be derived from raw click data, for example, as the number of clicks on d for qₛ, given by TF(d, qₛ)=C(d, qₛ), the number of times d was the only clicked document for qₛ, given by TF(d, qₛ)=OnlyC(d, qₛ) and so forth, or can be given by a heuristic function:

$${TF}_{h} ( d , {q}_{s} ) = \frac{c ( d , {q}_{s} + β ⋆ LastC ( d , {q}_{s} ) )}{Imp ( {dq}_{s} )} \qquad ( 1 )$$

where Imp(d, qₛ) is the number of impressions where d is shown in the top ten results for qₛ, C(d, qₛ) is the number of times d is clicked for qₛ. LastC(d, qₛ)ₛ) is the number of times d is the temporally last click for qₛ, and β is a tuned parameter that is set to 0.2 in one implementation. Because the last clicked document for a query is a good indicator of user satisfaction, the score is increased in proportion to β by the last click count. Note that other known heuristic functions may be used, including those that also take into account the dwell time of the click, which assume for example that reasonably long dwell time (e.g., ten to sixty seconds) is a good indicator of user satisfaction.

The click field for the document d may be represented by a vector of term frequencies 116, d=d₁, . . . , d_{Q}, where Q is the number of unique session queries in the click field for d and dᵢ=TF(d, qₛ_{ᵢ}), the term frequency function of the ith session query. Note that hat here a “term” is a “whole query,” however a term may also be defined as a single term within a query. Consider the task of determining the relevance of a document d to a user query q using only the click field. One technique is to equate the relevance function with the term frequency function of the qₛ_{ᵢ} that exactly matches q, i.e., assign the pair (d, q), a relevance function score of TF(d, qₛ_{ᵢ})=dᵢ, where qₛ_{ᵢ}=q. If no such qₛ_{ᵢ} exists, the relevance function equals zero. Sorting by relevance scores then obtains a ranking of documents for query q. The technique of using the term frequency function for query q, TF(d, q), is considered a relevance function herein.

In general, web search training data is a set of input-output pairs (x, y), where x is feature vector that represents a query-document pair (d, q) and y is a (typically) human-judged label indicating the relevance of q to d on a 5-level relevance scale, 0 to 4, with 4 as the most relevant. The pairs may comprise English queries sampled from query log files of a commercial search engine and corresponding URLs. On average, a typical query may be associated with 150-200 documents (URLs) and each query-document pair has a corresponding label. The query session logs (e.g., collected for year) may include on the order of millions of session query-document pairs, each with a feature vector containing some number of raw click features for example, among which the significant features include click counts, last click counts, the number of impressions, and the dwell time.

Consider that the optimal scoring function Score(d, q), is the optimal ranking function, where the value of Score(d, q) indicates the relevance of d given q. Therefore, the learning algorithm needs to be able to optimize the scoring function with respect to a cost function that is the same as, or as close as possible to, measures used to assess the quality of a web search system, (such as Mean Average Precision (MAP) and mean Normalized Discounted Cumulative Gain (NDCG)). For example, Mean NDCG is defined for query q as:

$$Mean N D C G @ L = \frac{100}{N ⋆ Z} {\sum }_{q = 1}^{N} {\sum }_{r = 1}^{L} \frac{{2}^{l ( r )} - 1}{log ( 1 + r )} \qquad ( 2 )$$

where N is the number of queries, l(r)ε{0, . . . , 4} is the relevance label of the document at rank position r and L is the truncation level to which NDCG is computed. Z is chosen such that the “perfect” ranking would result in NDCG@L_{q}=100, and is set to model user behavior

Given training data, many learning algorithms can be applied to incorporate the raw click features in a scoring function that is optimized for web search, such as RankSVM or RankNet. In one implementation, the LambdaRank algorithm (e.g., one or more non-linear versions, a state-of-the-art neural network ranking algorithm, as described for example in U.S. patent application publication no. 20090276414) is used because it can directly optimize a wide variety of measures that are used to evaluate a web search system such as MAP and mean NDCG. LambdaRank is a neural net ranker that maps a feature vector x to a real value score that indicates the relevance of a document given a query. For example, a linear LambdaRank simply maps x to Score(d, q) with a learned weight vector w such that Score(d,q)=w x. Note that raw click features include number of clicks, number of last clicks, number of only clicks, dwell time, impressions, position-based features, as well as a heuristic function, such as described above. The learned term frequency function 102 is also referred to herein as TF_{λ}.

The above-described method can only use a small portion of human-judges in the training data due to the small overlap of query-document pairs in the session data and in the training data, which leads to limited training data for scoring function learning. Further, the method assumes that the optimal scoring function used for term weight computation (i.e., term weighting function) can be obtained by optimizing the scoring function as if it were to be used as a ranker for document retrieval. However, the assumption may not always hold because most term weighting functions do not solely depend upon raw term frequency. For example, in the known BM25 term weighting function, the term frequency formula is a nonlinear transformation of raw term frequency, and other information such as document frequency and document length is also used.

Thus, as generally represented in FIG. 2, instead of learning a term frequency function that maps raw click features to term frequency, an alternative method is to select a subset of some number of the available raw click features 220, (e.g., the click count, the last click count, the first click count, the only click count, the number of impressions, the dwell time, as well as TFₕ and the learned term frequency function 102, TF_{λ}), and learn a combined (e.g., nonlinear) model 222 over these features, e.g., with the features considered functions 224. Note that processing to obtain the functions (e.g., TFₕ and TF_{λ}) as described above are represented by block 226. The nonlinear model 222, generally, is a weighted combination of term frequency functions 224 and may be treated as a relevance function based on the click field.

A benefit of this approach is that it allows defining term frequency functions and combining them. Other functions such as inverse document frequency, functions over other fields, and so on, also may be easily added to the model. For example, TFₜ (described above) may be defined as the sum of the click counts of all queries in the query click field which contain the input query term t. Note that this approach allows learning a term weighting for each term t in the query separately.

A relevance function is thus learned by combining the term frequency functions; thus the optimal learning result transfers to the optimal Web search result as much as possible. In one implementation, training with labeled training data 228 is performed using LambdaRank as the ranking algorithm 230.

### Exemplary Operating Environment

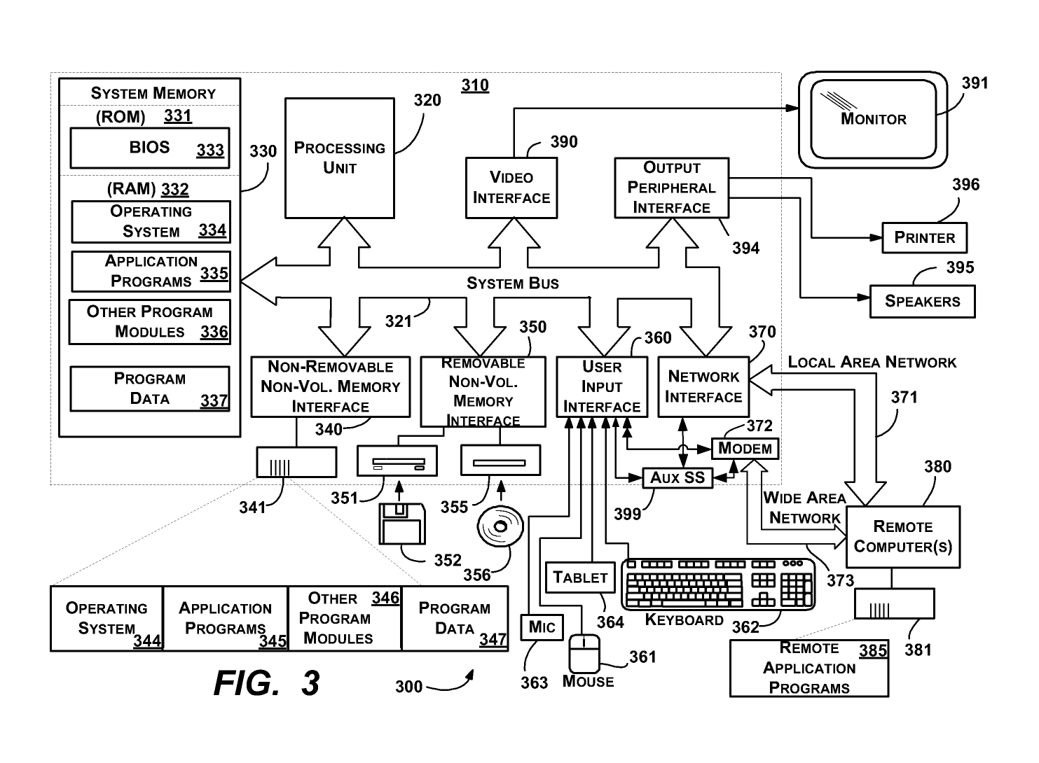

FIG. 3 illustrates an example of a suitable computing and networking environment 300 on which the examples of FIGS. 1-5 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor, comprising:
processing query data into query click field data; and
learning a term frequency function from a plurality of features of the query click field data, including by using labeled training data and a machine learning algorithm to find weights for the term frequency function.

2. The method of claim 1 further comprising, selecting the machine learning algorithm to optimize a scoring function with respect to a cost function that corresponds to a quality measure for an application.

3. The method of claim 2 wherein the quality measure corresponds to a web search application.

4. The method of claim 1 wherein processing query the data comprises determining a number of clicks, a number of last clicks, a number of only clicks, a dwell time, a click order, time before click, or a number of impressions, or any combination of a number of clicks, a number of last clicks, a number of only clicks, a dwell time, a click order, time before click, or a number of impressions.

5. The method of claim 1 wherein processing query the data comprises determining position-based features.

6. The method of claim 1 wherein processing query the data comprises computing a heuristic function as a feature.

7. The method claim 1 further comprising, via a ranking algorithm, combining the term frequency function with one or more other functions to produce a relevance function.

8. The method of claim 7 wherein the one or more other functions include at least one click feature or a heuristic function, or both at least one click feature and one heuristic function.

9. In a computing environment, a system comprising, a mechanism that processes collected data into one or more features or one or more functions representative of query click data, or both one or more features and one or more functions representative of query click data, and a learning algorithm that learns weights of terms of a term frequency function from the one or more features or one or more functions, or both, by using labeled training data.

10. The system of claim 9 wherein the learning algorithm comprises RankNet, LambdaMART, RankSVM or LambdaRank.

11. The system of claim 9 wherein the one or more features or one or more functions representative of query click data comprise a heuristic function.

12. The system of claim 9 wherein the one or more features or one or more functions representative of query click data comprise a number of clicks, a number of last clicks, a number of only clicks, a dwell time, one or more position-based features, or a number of impressions, or any combination of a number of clicks, a number of last clicks, a number of only clicks, a dwell time, one or more position-based features, or a number of impressions.

13. The system of claim 9 further comprising a web search application that uses the term frequency function in ranking relevance of documents to a query.

14. The system of claim 9 further comprising a ranking algorithm that combines the term frequency function with one or more other functions to produce a relevance function.

15. The system of claim 9 wherein the ranking algorithm comprises RankNet, LambdaMART, RankSVM or LambdaRank.

16. The system of claim 9 wherein the collected data comprises a query log, a toolbar log, a browser log, or other user feedback log.

17. In a computing environment, a method performed on at least one processor, comprising:
learning a term frequency function from query click field data;
combining the term frequency function with one or more other functions to produce a relevance function; and
using the relevance function to rank relevance of documents to a query.

18. The method of claim 17 wherein learning the term frequency function comprises processing query data into the features, and using labeled training data to find weights for terms of the term frequency function

19. The method of claim 17 wherein combining the term frequency function with one or more other functions comprises computing a heuristic function as a feature.

20. The method of claim 17 wherein combining the term frequency function with one or more other functions comprises obtaining features corresponding to a number of clicks, a number of last clicks, a number of only clicks, a dwell time, one or more position-based features, or a number of impressions, or any combination of a number of clicks, a number of last clicks, a number of only clicks, a dwell time, one or more position-based features, or a number of impressions.
